(19) United States
(12) Patent Application Publication
(10) Pub. No.: US 2023/0031377 A1
(43) Pub. Date: Feb. 2, 2023

(54) LABEL APPLICATION SYSTEM WITH A LABEL PRINTER ATTACHABLE TO A ROBOTIC ARM

(71) Applicant: Zebra Technologies Corporation, Lincolnshire, IL (US)

(72) Inventors: David F. Beck, Exeter, RI (US); Richard J. Preliasco, North Kingstown, RI (US); Edward Anthony Hackett, Surbiton (GB)

(21) Appl. No.: 17/389,998

(22) Filed: Jul. 30, 2021

(51) Int. Cl. B25J 9/16; G06F 3/12; G06K 9/00; B25J 19/02

(52) U.S. Cl. CPC B25J 9/1679; G06F 3/1204; G06F 3/1254; G06K 9/00671; G06F 3/1264; B25J 19/023; G06F 3/1288; G06K 2209/19

(57) ABSTRACT

In some implementations, a system may receive, from a camera, an image that depicts an object on a conveyor. The system may cause, based on an image processing model indicating that the image depicts the object, a robotic arm to attach to a label printer. The system may determine, using the image processing model, an object position of the object on the conveyor. The system may cause the robotic arm to move the label printer into an application position that corresponds to the object position on the conveyor. The system may cause the label printer to print a label. The system may cause the label printer to apply the label to the object.

### TECHNICAL FIELD

The present disclosure relates generally to a labelling system and, for example, to a label application system with a label printer that is attachable to a robotic arm.

### BACKGROUND

A supply chain process of a logistics system, such as a warehousing system or transportation system, typically involves using labels (e.g., printed labels and/or radio frequency identification (RFID) tags) to mark, track, locate, and/or route objects that are being stored in a location and/or transported between locations. The object may have various sizes, shapes, and/or be configured in various positions on a conveyor that is used to process and/or distribute the objects for labelling. Accordingly, there is a need for a label application system that can adapt to the various and/or unique configurations of objects that are to receive labels.

### BRIEF DESCRIPTION OF THE DRAWINGS

FIGS. 1A-1E are diagrams of one or more example implementations described herein.

FIG. 2 is a diagram of an example implementation of a label application system described herein.

FIG. 3 is a diagram of an example implementation of a configuration of a label printer and a robotic arm described herein.

FIG. 4 is a diagram of an example implementation of a label printer described herein.

FIG. 5 is another diagram of an example implementation of the label printer of FIG. 4.

FIG. 6 is a diagram of an example environment in which systems and/or methods described herein may be implemented.

FIG. 7 is a diagram of example components of one or more devices of FIG. 6.

FIGS. 8 and 9 are flowcharts of an example processes relating to a label application system that utilizes a label printer that is attachable to a robotic arm.

### DETAILED DESCRIPTION

The following detailed description of example implementations refers to the accompanying drawings. The same reference numbers in different drawings may identify the same or similar elements.

In automated labelling systems, a label can be applied to an object or item (e.g., an object or item that is to be stored, tracked, and/or transported) via a robotic device. For example, a system (e.g., an automated system of a warehouse or transportation center) may cause a printer to print a label, cause (e.g., via robotics instructions) the robotic device to retrieve the label from the printer (e.g., using a grasping mechanism of a robotic arm), and cause the robotic device to apply the label to the object using a label applicator of the robotic device (e.g., a label application mechanism on an end of a robotic arm). In some instances, a conveyor or other type of object moving system may move objects into a position that is within a proximity of the robotic device and/or the printer. The robotic device may be programmed and/or configured (e.g., in association with a camera or other device of the automated labelling system) to identify an object, determine and/or track a location of the object on the conveyor, and apply a label when the object is within a label application zone. The label application zone may be a space (or area) through which the object passes on the conveyor and can be reached by a label application mechanism of the robotic device. In such cases, the speed at which the conveyor can supply objects to the robotic device to receive labels may depend on the duration of time for the system to print a label, cause a robotic device to retrieve the label, and cause the robotic device to move into position to apply the label to an object.

Delays or extended durations in printing, retrieving, and/or applying a label can increase waste within the system. For example, power resources may be wasted by powering idle devices or components of the system that are waiting for a label to be applied to the object, computing resources (e.g., processor resources and/or memory resources) may be wasted by monitoring statuses of the system during the delays, network resources or communication resources used to communicate the statuses may be wasted during the delays, and so on. Accordingly, there is a need for a label application system that reduces a duration of time that is required to print, obtain, and/or apply a label to an object.

Some implementations described herein enable an automated system to quickly and efficiently apply a label to an object that is being processed and/or transported by the automated system. For example, a label application system may utilize a robotic device, such as a robotic arm, that is equipped with a label printer that can print and apply the label to an object (e.g., using a tamp of the label printer that is actuated via power from the robotic arm). Accordingly, the robotic arm can position the label printer within a label application zone near a conveyor (e.g., a space above and/or within a threshold distance of the conveyor) that is transporting objects. While the label printer is in the label application zone, the label application system can cause the label printer to print labels, which can then be applied to objects as the objects are passed through the label application zone by the conveyor.

In this way, the label application system may utilize a robotic device and a printer configuration that does not require movement of the robotic device to retrieve a printed label from a separate printer and/or does not require movement of the robotic device to position the label in a label application zone to permit the label to be applied to an object, thereby reducing a duration of time to print, obtain, and apply the label to an object (e.g., because the time required to move the robotic device to obtain labels and reposition the robotic device to apply the labels between applications on objects is eliminated). As a result, the label application system, as described herein, may more quickly and efficiently label objects that are being processed and/or transported (e.g., within a logistics system).

As described herein, the label application system may receive, from a camera, an image that depicts an object on a conveyor; cause, based on an image processing model indicating that the image depicts the object, a robotic arm to attach to a label printer; determine, using the image processing model, an object position of the object on the conveyor; cause the robotic arm to move the label printer into an application position that corresponds to the object position on the conveyor; cause the label printer to print a label; and cause the label printer to apply the label to the object based on the conveyor aligning the object position with the application position.

Although some examples herein are described in connection with a printed label created by a label printer, such examples may similarly apply to another type of physical marker, such as a radio frequency identification (RFID) tag created by an RFID printer.

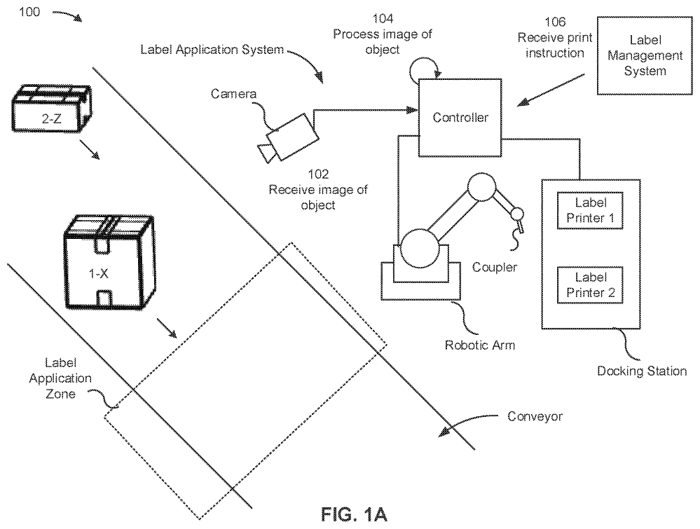

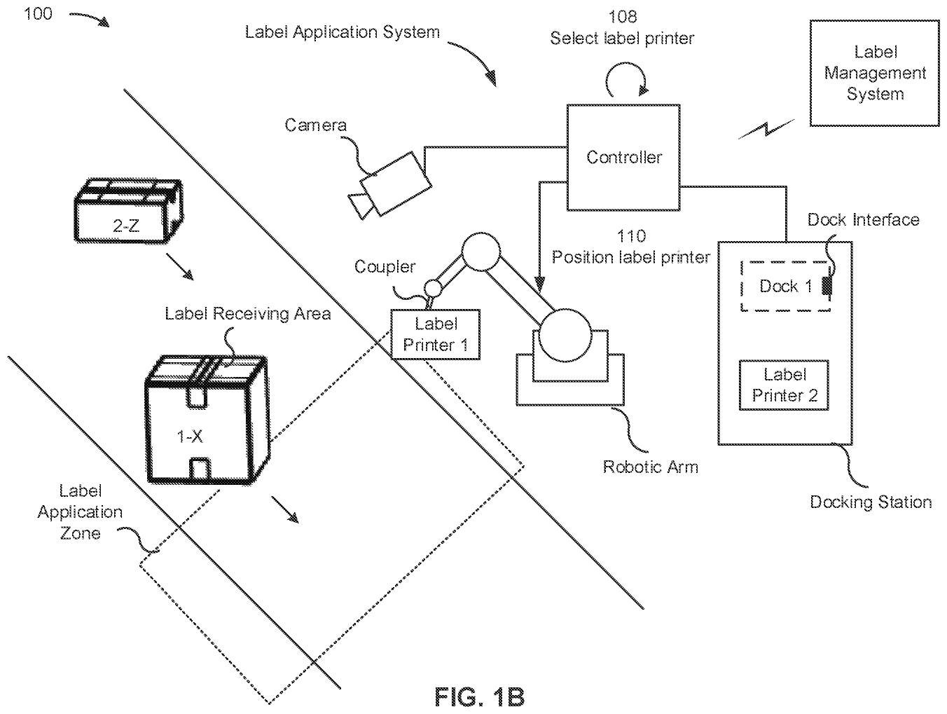

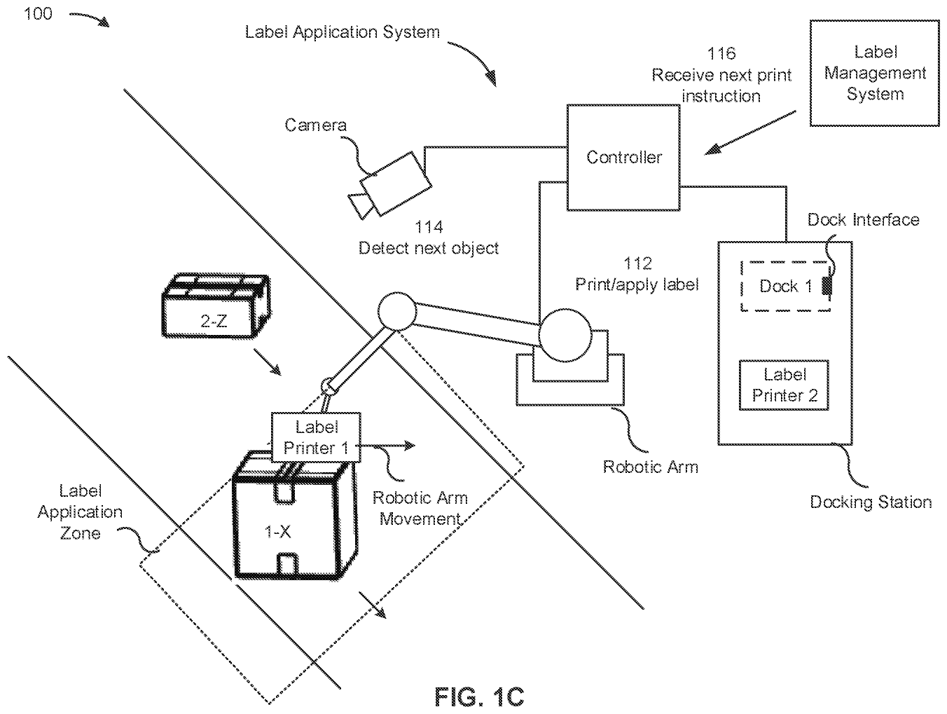

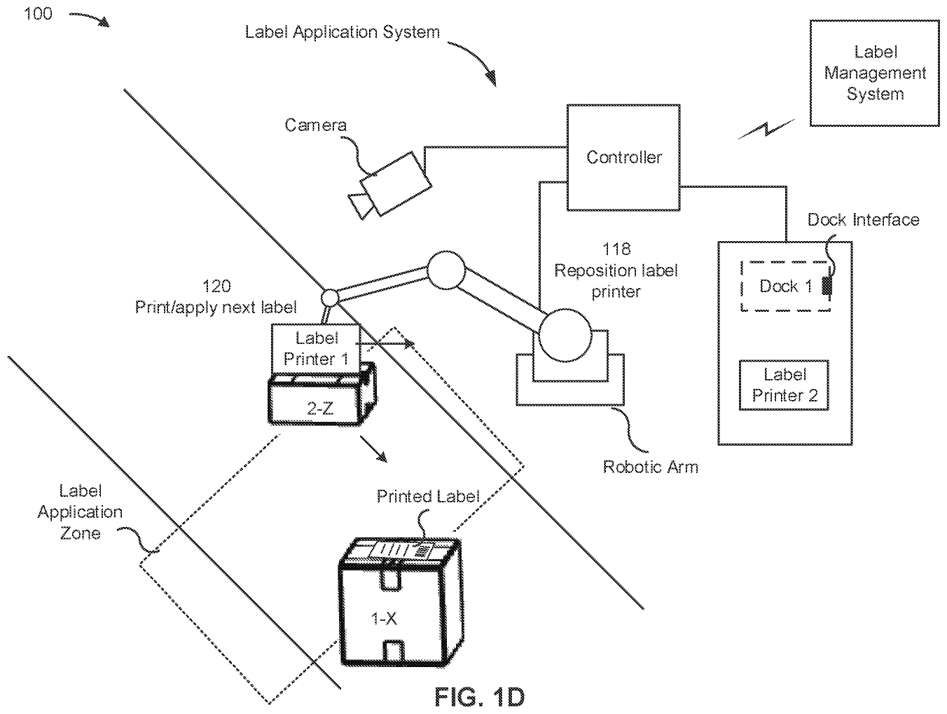

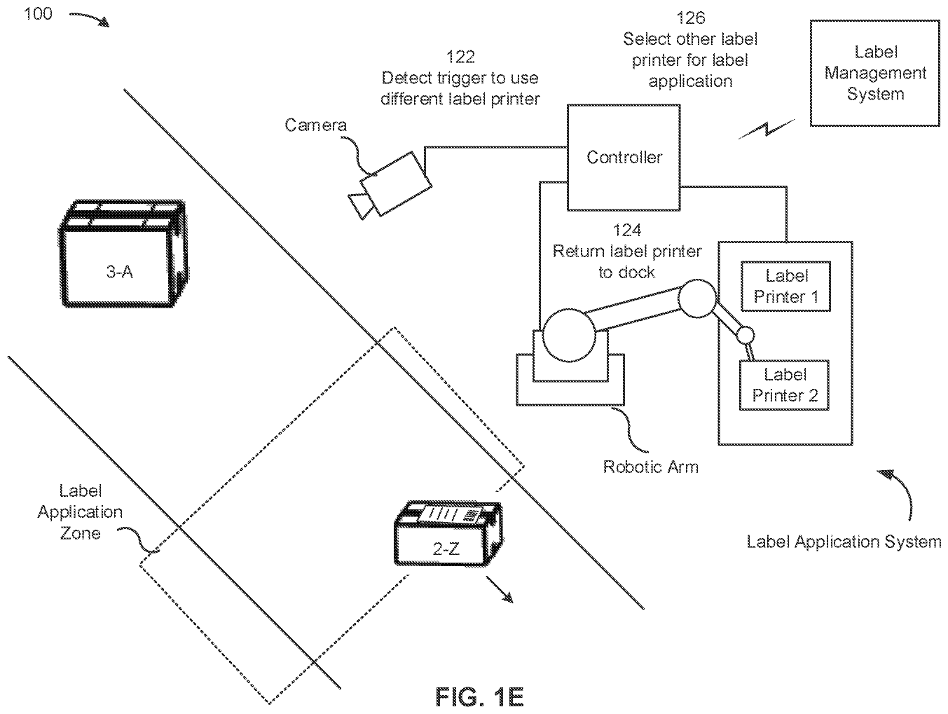

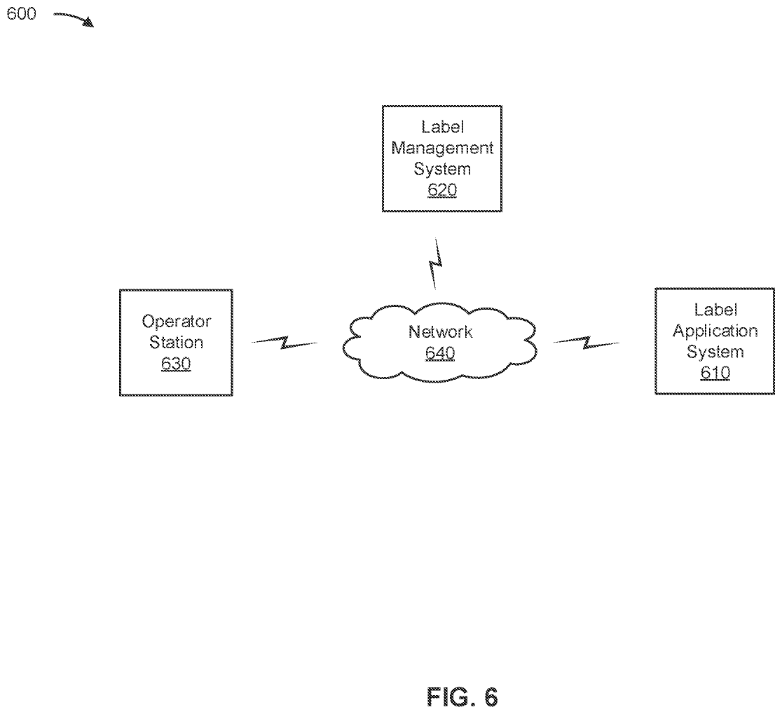

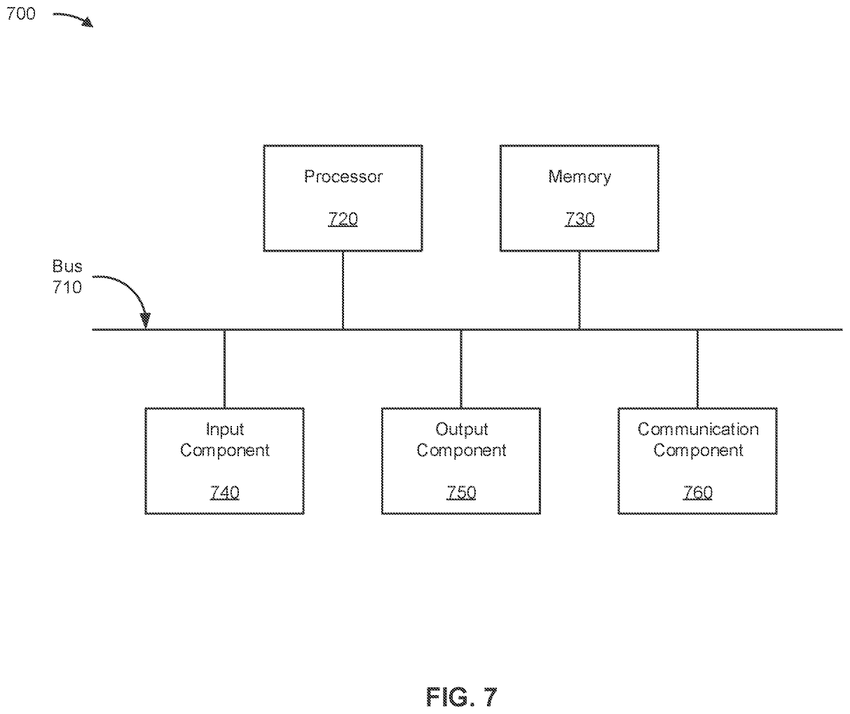

FIGS. 1A-1E are diagrams of an example implementation 100 associated with a label application system described herein. As shown in FIGS. 1A-1E, example implementation 100 includes a label application system and a label management system. In example implementation 100, the label application system includes a controller, a camera, a docking station, one or more label printers (shown as “Label Printer 1” and “Label Printer 2”), and a robotic arm. These devices are described in more detail below in connection with FIG. 6 and FIG. 7.

As shown in FIGS. 1A-1E and described below in connection with example implementation 100, an object may be conveyed into a label application zone, within which the label application system may apply a label to the object, as described herein. In some implementations, the conveyor may be associated with and/or included within the label application system. In such a case, the label application system may control a speed and/or direction of the conveyor in order to control a speed and/or direction of objects on the conveyor.

As shown in FIG. 1A, and by reference number 102, the label application system may receive an image of an object. The controller of the label application system may receive the image (or video that includes multiple image frames) from the camera. In some implementations, the label application system may include or receive images from multiple cameras that are mounted at various locations throughout the physical environment of the label application system. For example, a camera may be mounted to a support structure (e.g., a gantry) of the conveyor, a camera may be mounted to the robotic arm, and/or a camera may be mounted to one or more of the label printers in order to permit the label application system to monitor the desired portion of the conveyor and/or track a position of an object on the conveyor. In example implementation 100, the camera (and/or one or more other cameras) may be configured to stream images depicting a portion of the conveyor that receives objects before the objects reach the label application zone on the conveyor. In this way, via the streamed images, the label application system may monitor the portion of the conveyor to detect an incoming object that is to receive a label, as described elsewhere herein.

In some implementations, the camera may be associated with an actuable mounting system that permits the camera to capture images of various portions of the conveyor. In some implementations, the camera is configured to capture and/or provide images to the controller based on detecting motion on the conveyor and/or based on detecting the objects. For example, the camera and/or the controller may use a motion sensor and/or an optical flow analysis that includes a comparison of images within an image stream. In this way, based on indication motion from the motion sensor and/or certain differences between the images, the camera and/or the label application system may detect that an object is approaching the label application zone.

As further shown in FIG. 1A, and by reference number 104, the label application system may process the image of the object. For example, the label application system may process the image using an image processing model that is configured to identify one or more characteristics of the object. The image processing model may utilize any suitable computer vision technique to identify the object within the image and/or determine one or more characteristics of the object as described herein. For example, a computer vision technique of the image processing model may include one or more of an image recognition technique (e.g., an Inception framework, a ResNet framework, and/or a Visual Geometry Group (VGG) framework), an object detection technique (e.g., a Single Shot Detector (SSD) framework, and/or a You Only Look Once (YOLO) framework), an object in motion technique (e.g., an optical flow framework), an optical character recognition technique, among other examples.

For example, one or more characteristics may include a position of the object on the conveyor, a size of the object, a shape of the object, a type of the object, an identifier of the object, and/or a label receiving area of the object, among other characteristics. The position of the object (which may be referred to herein as an “object position”) may include or be defined by an orientation of the object (e.g., relative to a center axis or other reference point of the conveyor, relative to a location of the camera, and/or relative to a location of the robotic arm), and/or a location of the object on the surface of the conveyor (e.g., relative to a reference point of the conveyor, relative to a location of the camera, and/or relative to a location of the robotic arm). The position of the object may be based on and/or relative to a reference point of the conveyor (e.g., a portion of the conveyor that is defined by coordinates that are specific to a reference grid associated with a surface of the conveyor and/or rollers of the conveyor). For example, while the position of the object in space (or within the physical environment of the label application system) may change as the conveyor transports the object, the position of the object relative to the conveyor may be constant (e.g., because the position of the object is defined by the reference point of the conveyor). The reference point may be determined based on and/or correspond to one or more features of the conveyor. For example, a feature may include an edge of the conveyor, a rail of the conveyor, a gantry of the conveyor, and/or a marking associated with the conveyor. Accordingly, based on processing one or more images from the camera that depict the reference point or features, the label application system (e.g., via the controller and/or the image processing model) may determine the position of the object relative to the conveyor.

The image processing model may be configured to output and/or generate the one or more characteristics of the object to permit the controller to control the robotic arm to print and/or apply a label to the object, as described elsewhere herein. For example, the controller may utilize any suitable motion analysis technique to track a position of the object (e.g., according to timestamps of captured and/or analyzed) and correspondingly utilize any suitable robotic control technique to calculate robotic coordinates (e.g., spatial coordinates or three-dimensional coordinates associated with the robotic arm) used to control the robotic arm according to the tracked position (and/or other characteristics) of the object.

In some implementations, the image processing model may be configured to analyze the one or more images to detect specific and/or unique characteristics associated with a particular object. For example, because individual objects may be configured to receive different labels (rather than a same label being applied to every object), the objects may include an object identifier, such as a text identifier, a barcode, or other unique marking that is known and/or associated with the label application system and/or label management system. As shown in FIG. 1A, a first object may be identified by an object identifier “1-X,” and a second object may be identified by an object identifier “2-Z.” In some implementations, the individual characters may be associated with certain mappings and/or codes that can be interpreted by the controller to identify content that is to be printed on a label for the object, to identify a type of label that is to be applied to the object, to identify a type of printer that is to be selected for printing and/or applying a label to the object, and so on. Accordingly, the label application system and/or the image processing model may be configured to identify and/or detect object identifiers on objects depicted in the images.

In some implementations, the image processing model and/or label application system may be configured to identify a label receiving area of the object. The label receiving area may be marked on the object (e.g., via a border of the label, an identifier of the label receiving area, or type of other marking) to permit the image processing model and/or the label application system to identify the label receiving area. Additionally, or alternatively, because individual objects may have previously received other labels or markings in various locations and/or may have damaged areas (e.g., dents, holes, and so on that may not be conducive to receiving a label), the label receiving areas for the individual boxes may be unmarked and/or different from one another. For example, the label receiving areas may be positioned in various locations of the objects or various orientations of the object, and/or may have different sizes. Accordingly, the label application system and/or the image processing model may be configured to identify a label receiving area of the object that may be best suited for receiving the label. In such a case, the label application system and/or the image processing model may analyze the object to find a portion of the object that is capable of receiving a label that has a particular size. Accordingly, the label receiving area may correspond to an area on a surface of the object that is at least the size of a label that is to be applied to the object. Additionally, or alternatively, the label receiving area may be an area on the surface of the object that does not include any other labels, any other labels, or any damaged portions of the object (e.g., to ensure that the label is likely to be attached to the object without obstructing access to the other labels or other markings and/or to ensure that the label does not become detached from the object by being applied to a damaged area of the object).

In this way, using the image processing model, the label application system may analyze images depicting an object in order to apply a label on the object using a robotic arm, as described elsewhere herein.

As further shown in FIG. 1A, and by reference number 106, the label application system may receive a print instruction from the label management system. The print instruction may indicate content that is to be printed on a label by one or more of the label printers. In some implementations, the print instruction may be the same for multiple objects. For example, the print instruction may be the same for all objects. Additionally, or alternatively, the label application system may receive individual print instructions for individual objects (or types of objects) that are being supplied for label application by the conveyor. For example, the print instruction may indicate that an object that has a particular characteristic (e.g., a particular identifier or is a particular type) is to receive a label with corresponding content. Accordingly, based on identifying and/or detecting an object identifier of the object, the label application system may determine content that is associated with the object identifier to permit the label application system to print the content to a label and apply the label to the object, as described herein.

In some implementations, the print instruction may specify which label printer, of the plurality of printers, are to be used to print and/or apply the label to an object. For example, the print instruction may include a printer identifier or other indication that permits the label application system to select the corresponding printer for printing content to a label and applying the label to an object.

As shown in FIG. 1B, and by reference number 108, the label application system may select a label printer. In some implementations, the label application system may select a label printer based on a status of the individual available label printers. For example, the status may correspond to an operability status of the label printers. More specifically, the label application system may select a label printer that is loaded with a minimum threshold of print media (e.g., a minimum quantity of paper labels, a minimum length of a roll of labels, and so on). Additionally, or alternatively, the label application system may select a default label printer and/or a label printer that is not experiencing or known to be experiencing any printing errors (e.g., printhead errors, print media jamming, or the like).

In some implementations, the label application system may select the printer based on an object identifier that is detected on the object. For example, if an object is to receive a particular type of label (e.g., a label that has a particular size, a particular adhesive, or other particular characteristic), the object identifier may be mapped (e.g., via a print instruction from the label management system) to a particular label printer that is to be used to print and/or apply the label to the object.

Based on a selection of a first label printer (Label Printer 1), the label application system may cause the robotic arm to attach to the label printer in order to print and/or apply a label to an object, as described herein. For example, the label application system may control, using any suitable technique, the robotic arm to attach to the label printer via a coupler of the robotic arm and/or an electromechanical coupling of the label printer. The coupler of the robotic arm and/or the electromechanical coupling of the label printer may include one or more electrical terminals that facilitate communication between the robotic arm and the label printer. Additionally, or alternatively, the coupler and/or the electromechanical coupling may be configured for transfer of electrical power from the robotic arm to one or more components of the label printer. In this way, the electrical power can be supplied to the label printer from the robotic arm to permit the label printer to utilize the electrical power to perform a printing operation to print a label and/or to apply the label to an object using a tamp of the label printer. Additionally, or alternatively, the coupler and/or the electromechanical coupling of the label printer may include one or more mechanical connectors that permit the robotic arm to actuate a mechanical component (e.g., a tamp) of the label printer.

Accordingly, the label application system may cause the robotic arm to couple to an electromechanical coupling of the label printer to permit the robotic arm to position the label printer for printing and/or applying a label to an object.

As further shown in FIG. 1B, and by reference number 110, the label application system may position the label printer. For example, the controller may control one or more devices (e.g., sensors, drives, motors, and/or the like) of the robotic arm to move the label printer into an application position that corresponds to an object position on the conveyor. For example, the application position may correspond to an anticipated position of the first object within the label application zone (e.g., when the object position is within the label application zone).

The application position may align with a path of the object position on the conveyor. The path of the object position on conveyor may correspond to a path of movement of the object as the conveyor transports the object through the physical environment of the label application system. The controller may cause the robotic arm to move the robotic arm into a position that is determined and/or calculated based on the determined position of the object relative to the conveyor (e.g., a position determined using the image processing model) and/or the path of the position of the object on the conveyor. For example, the controller may convert image-based coordinates of an approaching object to robotic coordinates used to control a position of the robotic arm. In this way, the label application system may move the label printer into the application position that aligns with a path of the object and/or position of the object on the conveyor.

In some implementations, the robotic arm may move the label printer from a dock of the docking station that previously supported the label printer. For example, the dock of the docking station may include a dock interface that may facilitate communication between the controller of the label application system and the label printer (e.g., to communicate status information associated with the label printer, print instructions, and/or print settings for printer operations). Additionally, or alternatively, dock interface may permit the docking station to supply electrical power to the label printer while the label printer is in the dock. In this way, while the label printer is in the dock, the label printer may perform a print operation (e.g., a test print operation) and/or may actuate one or more components (e.g., an actuator of a print media door of the label printer that enables print media to be supplied to a roller of the label printer).

Accordingly, the label application system may position the label printer for printing and/or applying a label to an object.

As shown in FIG. 1C, and by reference number 112, the label application system may print and/or apply a label to the object. For example, the controller may cause the label printer to print the label according to the print instruction from the label management system. The controller may communicate the print instruction and/or control the label printer to perform a print operation via a wireless communication link between the controller and the label printer and/or a wired communication link of the robotic arm.

Once the label is printed and/or output from the label printer, the controller may cause the label printer to apply the label to the object. For example, the controller may cause the printer to apply the label to the object using a tamp. The controller may actuate the tamp via an actuator of the label printer and/or an actuator of the robotic arm. Additionally, or alternatively, the controller may cause the robotic arm to move along a trajectory, as the object passes along a path of the conveyor, that enables the label printer to apply the label to a label receiving area of the object. Similar to moving the robotic arm as described above, the controller may convert image-based coordinates that are indicative of a movement of the identified label receiving area into robotic coordinates corresponding to an anticipated motion of the label receiving area within the label application zone. The label application system may determine a trajectory of the robotic arm that corresponds to the anticipated motion of the label receiving area to enable the label printer (and/or the robotic arm) to apply the label to the object as the object passes through the label application zone (e.g., without stopping the conveyor and/or without stopping the object within the label application zone). As shown in FIG. 1C, the robotic arm movement may correspond to an alignment with an axis (e.g., a center axis, a longitudinal axis and/or a lateral axis) of the object and/or an alignment with a label receiving area of the object. Accordingly, the label application system, via the controller, may control the robotic arm to move the label printer across the label receiving area (so that the label is peeled, tamped, and/or adhered to the object within the label receiving area).

In this way, the label application system, as described herein, permits a label to be printed and applied to an object without inhibiting the progress of the object. Furthermore, the label application system may permit a label to be printed and applied to an object by a robotic arm (or a label printer attached to the robotic arm) without a label application mechanism (e.g., the label printer and/or a tamp of the label printer) of the robotic arm being removed from the label application zone.

As further shown in FIG. 1C, and by reference number 114, the label application system may detect a next object. Similar to detecting the first object (identified by “1-X”), the label application system may detect the next object (identified by “2-Z”) based on receiving images depicting the next object.

As further shown in FIG. 1C, and by reference number 116, the label application system may receive a next print instruction. For example, the label application system may obtain the next print instruction from the label management system using the object identifier (e.g., “2-Z”) on the object. For example, the label application system may send a request that indicates the object identifier to the label management system to permit the label management system to reply with a corresponding print instruction for the object. In this way, the label application system may receive a print instruction that includes content that is to be printed on a label for the next object.

As shown in FIG. 1D, and by reference number 118, the label application system may reposition the label printer. For example, the label application system, without removing the label printer from the label application zone, may move the label printer into a position that corresponds to an anticipated position of the object on the conveyor when the object reaches or is within the label application zone.

As further shown in FIG. 1D, and by reference number 120, the label application system may print and/or apply the next label to the next object. For example, the label application system may print and/or apply the label to the next object based on the determined position of the next object within the label application zone, as described elsewhere herein.

As shown in FIG. 1E, and by reference number 122, the label application system may detect a trigger to use a different label printer. For example, such a trigger may include the first label printer being exhausted of print media or reaching a threshold quantity of print media. Additionally, or alternatively, the trigger may include the first label printer experiencing an error (e.g., a printhead error, a print media jam, or the like). In some implementations, the trigger may include detecting that an incoming object is to receive a label from a different label printer (e.g., because the object is to receive a different sized label and/or a different type of label that is printed by another label printer other than the first label printer).

As further shown in FIG. 1E, and by reference number 124, the label application system may return the label printer to the dock. For example, based on detecting the trigger, the label application system may return the label printer to dock to permit the label application system to select another label printer from the docking station. Accordingly, if a label printer is exhausted of print media and/or experiences an error, rather than the label application system having to shut down the conveyor and/or stop the movement of the objects, the label application system may control the robotic arm to return the first label printer to the dock to permit the label application system to select another label printer to print and/or apply a label for other objects (e.g., the object identified by “3-A”). Furthermore, if the first label printer is exhausted of print media or does experience an error, the first label printer may be resupplied with print media while in the docking station and/or may receive maintenance to address the error (without having to shut down the label application system).

As further shown in FIG. 1E, and by reference number 126, the label application system may select another label printer for label application. For example, the label application system may select the second label printer based on being available to print and apply labels for other objects that are detected. Additionally, or alternatively, second label printer may be selected based on being associated with or mapped to a detected object (e.g., based on the object identifier on the object).

In this way, the label application system enables labels to more quickly be printed and applied to objects in a system that is configured for automated processing of the objects. Furthermore, the label application system may include multiple label printers (and/or multiple robotic arms) to reduce or prevent a likelihood of a shutdown of such an automated system. Accordingly, the label application system, as described herein, can prevent waste caused by delays in printing and applying labels to objects.

As indicated above, FIGS. 1A-1E are provided as an example. Other examples may differ from what is described with regard to FIGS. 1A-1E. The number and arrangement of devices shown in FIGS. 1A-1E are provided as an example. In practice, there may be additional devices, fewer devices, different devices, or differently arranged devices than those shown in FIGS. 1A-1E. Furthermore, two or more devices shown in FIGS. 1A-1E may be implemented within a single device, or a single device shown in FIGS. 1A-1E may be implemented as multiple, distributed devices. Additionally, or alternatively, a set of devices (e.g., one or more devices) shown in FIGS. 1A-1E may perform one or more functions described as being performed by another set of devices shown in FIGS. 1A-1E.

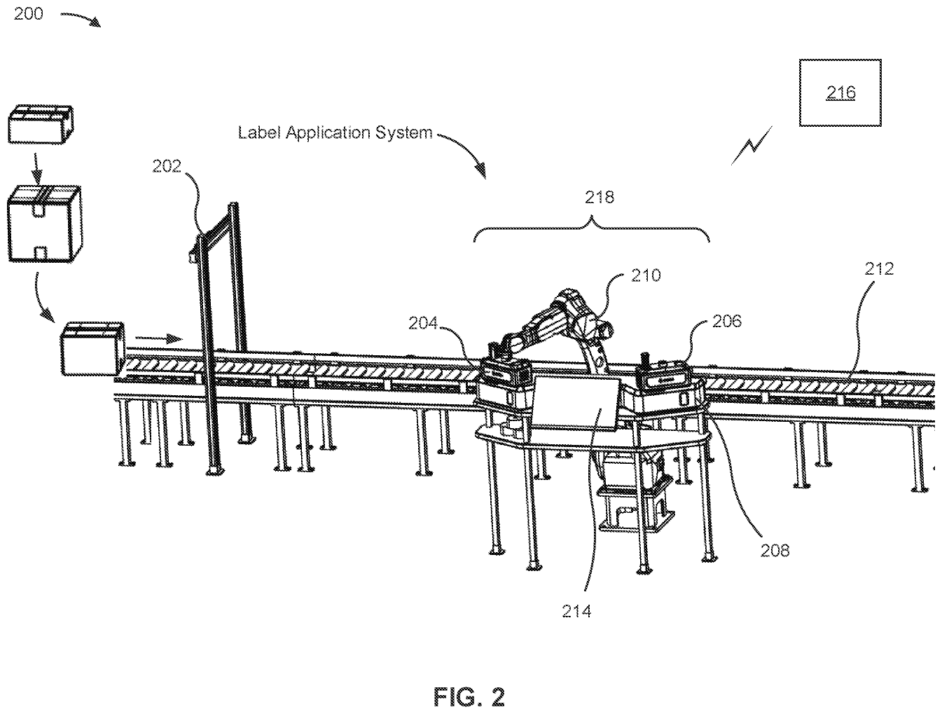

FIGS. 2-5 are diagrams of one or implementations of one or more components of a label application system described herein (e.g., the label application system of example implementation 100). FIG. 2 is a diagram of an example implementation of a label application system 200 described herein. As shown in FIG. 2, the label application system 200 includes a camera 202, a first label printer 204, a second label printer 206, a docking station 208, a robotic arm 210, a conveyor 212, and an operator station 214. A controller 216 of the label application system 200 may be configured to control the components or devices of the label application system 200 via wireless and/or wired communications. The operator station 214 may include one or more user interfaces that permit an operator of the label application system 200 configure settings of the label application system 200 (e.g., processing settings, print settings, and/or the like). Additionally, or alternatively, the operator station 214 may permit an operator to provide a print instruction to the label application system to cause the label application system to print and apply a label to an object according to the print instruction, as described elsewhere herein.

As shown in FIG. 2, the camera 202 may be positioned on a support upstream (relative to motion of the conveyor 212) from the robotic arm 210. Accordingly, a field of view of the camera may be upstream from the robotic arm 210 to permit the controller 216 to detect when objects are approaching the robotic arm 210. As shown, a label application zone 218 corresponds to a space, within a physical environment of the label application system 200, in which the conveyor 212 can convey an object and the robotic arm 210 can position the first label printer 204 and/or the second label printer 206.

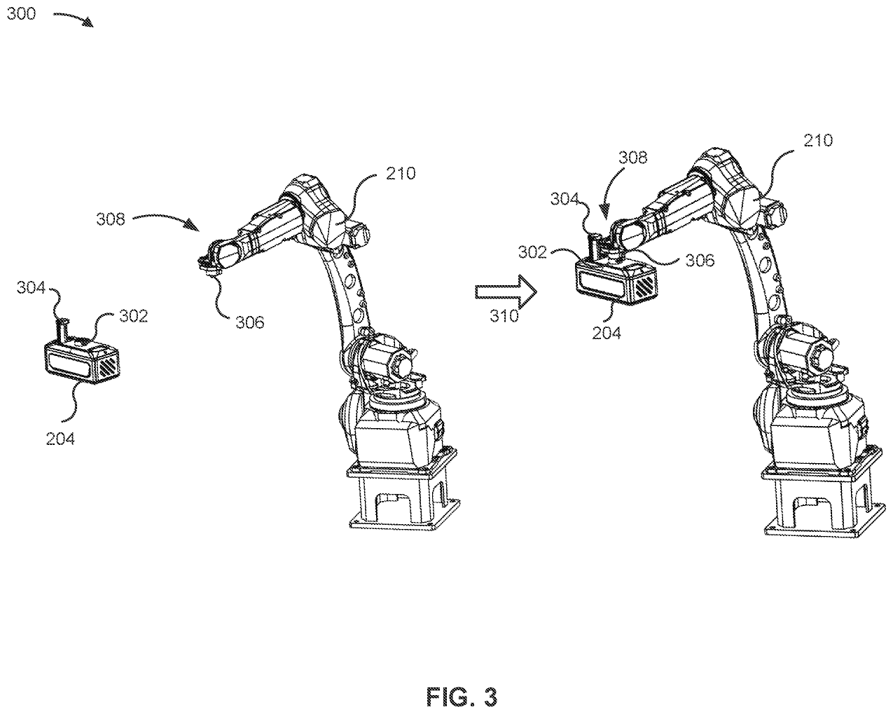

FIG. 3 is a diagram of an example implementation 300 of a configuration of the first label printer 204 and the robotic arm 210 described herein. As shown in FIG. 3, the first label printer 204 includes an electromechanical coupling 302 and a tamp 304. The robotic arm 210 includes a coupler 306 at a label application end 308 (e.g., a distal end) of the robotic arm 210. As further shown by reference number 310, when the robotic arm 210 is attached to the first label printer 204, the coupler 306 may electromechanically connect to the electromechanical coupling 302 to permit the robotic arm 210 to communicate with the first label printer 204 and/or supply power to the first label printer 204, as described elsewhere herein. In some implementations, the controller 216 may be configured to communicate with the first label printer 204 and/or facilitate a supply of power to the first label printer 204 based on whether the coupler 306 is electromechanically coupled with the electromechanical coupling 302. For example, the controller 216 may detect that the coupler 306 is electromechanically coupled with the electromechanical coupling 302 using a sensor (e.g., a sensor that detects contact between the coupler 306 and the electromechanical coupling 302), a detected communication between the first label printer 204 and the robotic arm 210, and/or the like.

In this way, the robotic arm 210 may attach to the first label printer 204 to permit the label printer to be used to print and apply a label to an object from the label application end 308 of the robotic arm 210.

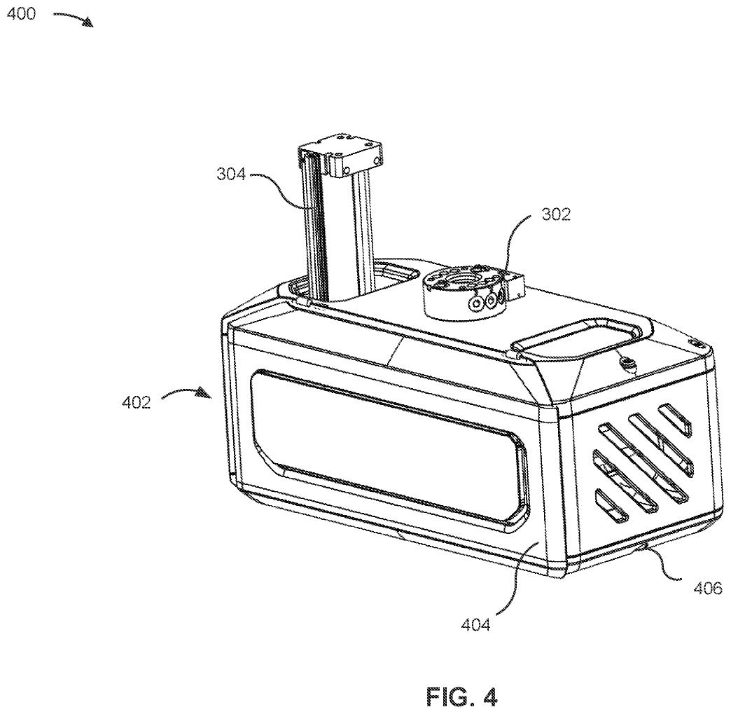

FIG. 4 is a diagram of an example implementation of a label printer 400 described herein. The label printer 400 may correspond to the first label printer 204 and/or the second label printer 206. As shown in FIG. 4, the label printer includes an electromechanical coupling 302 and a tamp 304. The tamp 304 may be positioned toward an output side 402 of the label printer 400 from which a printed label is output from the label printer 400.

The label printer 400 includes a print media door 404 that facilitates access to a print media receiving component (e.g., a print media roller of the label printer 400). In some implementations, the print media door 404 may be opened via an actuator of the label printer 400. The label printer 400 of FIG. 4 includes a dock terminal 406 that is configured to couple with a dock interface of the docking station 208. The dock terminal 406 may enable the controller 216 to communicate with the label printer 400 and/or supply power to the label printer via the dock interface and/or the docking station 208. In some implementations, the controller 216 may cause the actuator to automatically open the print media door upon the label printer 400 being returned to a dock of the docking station 208 and/or upon the label printer 400 receiving power from a dock interface of the docking station 208 via the dock terminal 406 (e.g., to permit print media to be resupplied to the label printer 400 after being exhausted from print operations and/or label applications, as described herein). In some implementations, the label printer 400 may include a battery. For example, the battery may store electricity that is used to power one or more components of the label printer 400. The electricity may be received via the dock terminal 406 when the label printer 400 is placed in a dock of the docking station 208 and/or may be received via the electromechanical coupling 302 when the label printer 400 is attached to the robotic arm 210.

The label printer 400 may be configured and/or designed to have a size and/or mass that satisfies a size threshold and/or mass threshold, respectively, that permit the label printer 400 to be attached to the label application end 308 of the robotic arm 210 and moved by the robotic arm 210 without slowing or inhibiting motion of the robotic arm 210 within a design threshold or a particular tolerance. Additionally, or alternatively, the size and/or mass of the label printer 400 may be configured according to a threshold speed at which a label application system is to process objects and/or receive application labels, as described herein.

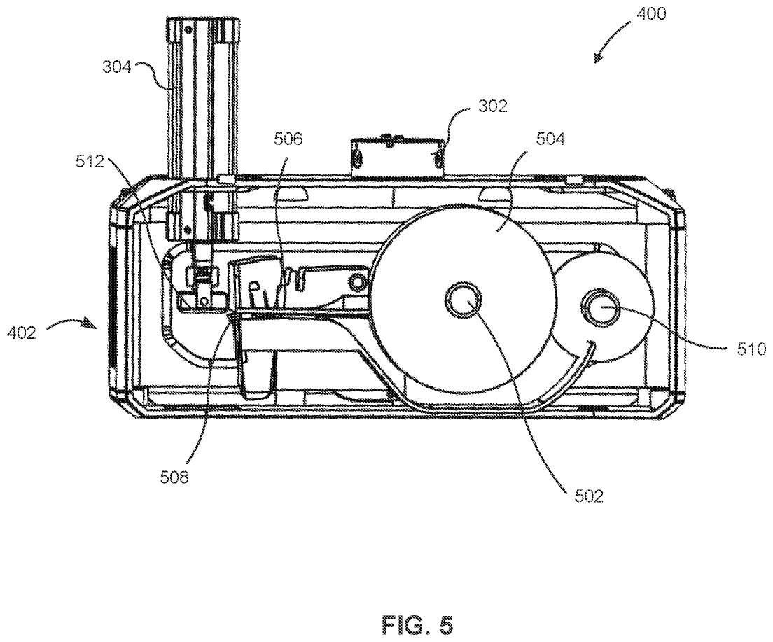

FIG. 5 is another diagram of an example implementation of the label printer 400. As shown in FIG. 5, the label printer 400 includes a print media roller 502 that holds a print media supply 504 (e.g., a roll of paper labels), a printhead 506, a label peeler 508, a liner spool 510, and a tamp head 512. The print media roller 502 may hold the print media supply 504 to permit labels of the print media supply 504 to receive content via the printhead 506. The labels may be peeled from a liner of the print media supply 504 and output from the label printer 400 toward the output side 402. The liner may be spooled by the liner spool 510 (e.g., until all labels on the print media supply 504 have been printed by (or received content from) the printhead 506).

The tamp head 512, may apply the label that is output from the label printer 400 by contacting or pressing the label to an object via an actuation of the tamp 304. The tamp 304 and/or the tamp head 512 may be hydraulically actuated (e.g., using an air-powered vacuum generator) and/or electronically actuated (e.g., using a motor).

In this way, a label printer may be configured to be arranged on a label application end of a robotic arm to permit a label application system to quickly and efficiently print and apply labels to objects that are being processed within an automated system.

As indicated above, FIGS. 2-5 are provided as an example. Other examples may differ from what is described with regard to FIGS. 2-5. The number and arrangement of devices shown in FIGS. 2-5 are provided as an example. In practice, there may be additional devices, fewer devices, different devices, or differently arranged devices than those shown in FIGS. 2-5. Furthermore, two or more devices shown in FIGS. 2-5 may be implemented within a single device, or a single device shown in FIGS. 2-5 may be implemented as multiple, distributed devices. Additionally, or alternatively, a set of devices (e.g., one or more devices) shown in FIGS. 2-5 may perform one or more functions described as being performed by another set of devices shown in FIGS. 2-5.

FIG. 6 is a diagram of an example environment 600 in which systems and/or methods described herein may be implemented. As shown in FIG. 6, environment 600 may include a label application system 610, a label management system 620, an operator station 630, and a network 640. Devices of environment 600 may interconnect via wired connections, wireless connections, or a combination of wired and wireless connections.

The label application system 610 includes one or more devices capable of receiving, generating, storing, processing, providing, and/or routing information associated with printing and applying a label to an object using a label printer that is attachable to a robotic arm, as described elsewhere herein. The label application system 610 may include a communication device and/or a computing device. For example, the label application system 610 may include a server, such as an application server, a client server, a web server, a database server, a host server, a proxy server, a virtual server (e.g., executing on computing hardware), or a server in a cloud computing system. In some implementations, the label application system 610 includes computing hardware used in a cloud computing environment. In some implementations, as described elsewhere herein, the label application system 610 may include a controller, a camera, a robotic arm, a label printer, and/or a conveyor.

The label management system 620 includes one or more devices capable of receiving, generating, storing, processing, providing, and/or routing information associated with a print instruction used by the label application system 610 to print and apply a label to an object, as described elsewhere herein. The label management system 620 may include a communication device and/or a computing device. For example, the label management system 620 may include a server, such as an application server, a client server, a web server, a database server, a host server, a proxy server, a virtual server (e.g., executing on computing hardware), or a server in a cloud computing system. In some implementations, the label management system 620 includes computing hardware used in a cloud computing environment.

The operator station 630 includes one or more devices capable of receiving, generating, storing, processing, and/or providing information associated with managing the label application system 610, as described elsewhere herein. The operator station 630 may include a communication device and/or a computing device. For example, the operator station 630 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The network 640 includes one or more wired and/or wireless networks. For example, the network 640 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 640 enables communication among the devices of environment 600.

The number and arrangement of devices and networks shown in FIG. 6 are provided as an example. In practice, there may be additional devices and/or networks, fewer devices and/or networks, different devices and/or networks, or differently arranged devices and/or networks than those shown in FIG. 6. Furthermore, two or more devices shown in FIG. 6 may be implemented within a single device, or a single device shown in FIG. 6 may be implemented as multiple, distributed devices. Additionally, or alternatively, a set of devices (e.g., one or more devices) of environment 600 may perform one or more functions described as being performed by another set of devices of environment 600.

FIG. 7 is a diagram of example components of a device 700, which may correspond to the label application system 610, the label management system 620, and/or the operator station 630. In some implementations, the label application system 610, the label management system 620, and/or the operator station 630 may include one or more devices 700 and/or one or more components of device 700. As shown in FIG. 7, device 700 may include a bus 710, a processor 720, a memory 730, an input component 740, an output component 750, and a communication component 760.

Bus 710 includes one or more components that enable wired and/or wireless communication among the components of device 700. Bus 710 may couple together two or more components of FIG. 7, such as via operative coupling, communicative coupling, electronic coupling, and/or electric coupling. Processor 720 includes a central processing unit, a graphics processing unit, a microprocessor, a controller, a microcontroller, a digital signal processor, a field-programmable gate array, an application-specific integrated circuit, and/or another type of processing component. Processor 720 is implemented in hardware, firmware, or a combination of hardware and software. In some implementations, processor 720 includes one or more processors capable of being programmed to perform one or more operations or processes described elsewhere herein.

Memory 730 includes volatile and/or nonvolatile memory. For example, memory 730 may include random access memory (RAM), read only memory (ROM), a hard disk drive, and/or another type of memory (e.g., a flash memory, a magnetic memory, and/or an optical memory). Memory 730 may include internal memory (e.g., RAM, ROM, or a hard disk drive) and/or removable memory (e.g., removable via a universal serial bus connection). Memory 730 may be a non-transitory computer-readable medium. Memory 730 stores information, instructions, and/or software (e.g., one or more software applications) related to the operation of device 700. In some implementations, memory 730 includes one or more memories that are coupled to one or more processors (e.g., processor 720), such as via bus 710.

Input component 740 enables device 700 to receive input, such as user input and/or sensed input. For example, input component 740 may include a touch screen, a keyboard, a keypad, a mouse, a button, a microphone, a switch, a sensor, a global positioning system sensor, an accelerometer, a gyroscope, and/or an actuator. Output component 750 enables device 700 to provide output, such as via a display, a speaker, and/or a light-emitting diode. Communication component 760 enables device 700 to communicate with other devices via a wired connection and/or a wireless connection. For example, communication component 760 may include a receiver, a transmitter, a transceiver, a modem, a network interface card, and/or an antenna.

Device 700 may perform one or more operations or processes described herein. For example, a non-transitory computer-readable medium (e.g., memory 730) may store a set of instructions (e.g., one or more instructions or code) for execution by processor 720. Processor 720 may execute the set of instructions to perform one or more operations or processes described herein. In some implementations, execution of the set of instructions, by one or more processors 720, causes the one or more processors 720 and/or the device 700 to perform one or more operations or processes described herein. In some implementations, hardwired circuitry may be used instead of or in combination with the instructions to perform one or more operations or processes described herein. Additionally, or alternatively, processor 720 may be configured to perform one or more operations or processes described herein. Thus, implementations described herein are not limited to any specific combination of hardware circuitry and software.

The number and arrangement of components shown in FIG. 7 are provided as an example. Device 700 may include additional components, fewer components, different components, or differently arranged components than those shown in FIG. 7. Additionally, or alternatively, a set of components (e.g., one or more components) of device 700 may perform one or more functions described as being performed by another set of components of device 700.

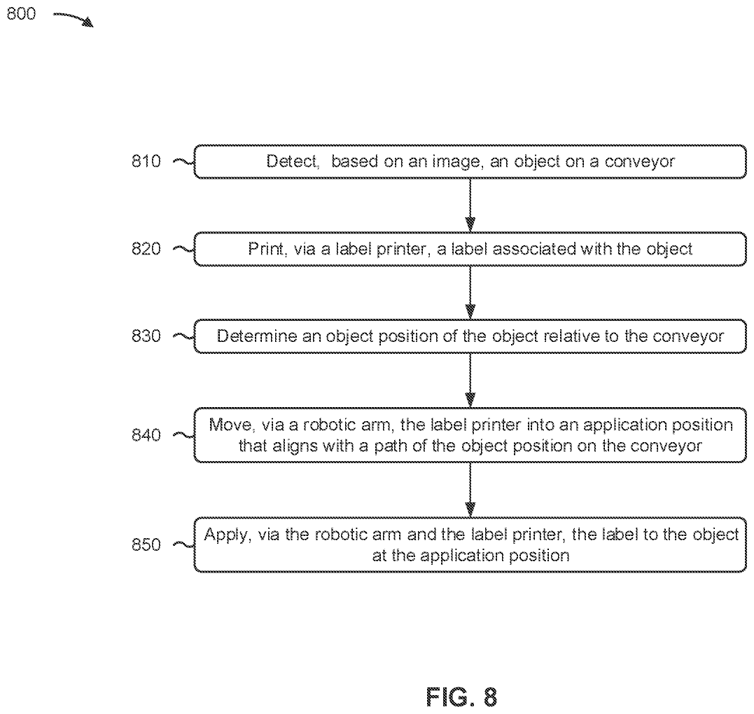

FIG. 8 is a flowchart of an example process 800 associated with a label application system described herein. In some implementations, one or more process blocks of FIG. 8 may be performed by a label application system (e.g., label application system 610 and/or a controller of the label application system). In some implementations, one or more process blocks of FIG. 8 may be performed by another device or a group of devices separate from or including the label application system, such as a label management system (e.g., the label management system 620) and/or an operator station (e.g., the operator station 630). Additionally, or alternatively, one or more process blocks of FIG. 8 may be performed by one or more components of device 700, such as the processor 720, the memory 730, the input component 740, the output component 750, and the communication component 760.

As shown in FIG. 8, process 800 may include detecting, based on an image, an object on a conveyor (block 810). For example, the label application system may detect, based on an image, an object on a conveyor, as described above. The object may be detected using an image processing model that is configured to identify the object on the conveyor as depicted in the image.

As further shown in FIG. 8, process 800 may include printing, via a label printer, a label associated with the object (block 820). For example, the label application system may print, via a label printer, a label associated with the object, as described above.

The label printer may be selected, from a plurality of label printers, to apply the label based on a print instruction associated with the object and the label. The label may be printed to include content that is associated with an object identifier that is indicated on the object.

As further shown in FIG. 8, process 800 may include determining an object position of the object relative to the conveyor (block 830). For example, the label application system may determine an object position of the object relative to the conveyor, as described above.

As further shown in FIG. 8, process 800 may include moving, via a robotic arm, the label printer into an application position that aligns with a path of the object position on the conveyor (block 840). For example, the label application system may move, via a robotic arm, the label printer into an application position that aligns with a path of the object position on the conveyor, as described above.

In some implementations, the label application system may move the label printer into the application position by causing the robotic arm to remove the label printer from a docking station controlling the robotic arm, wherein the docking station is configured to supply power to the label printer when the label printer is docked at the docking station, and wherein the label printer is to receive power from the robotic arm based on being attached to the robotic arm.

The robotic arm may be attachable to the label printer via a coupler of the robotic arm and an electromechanical coupling of the label printer. The electromechanical coupling may be configured to transfer electrical power from the robotic arm to one or more components of the label printer

As further shown in FIG. 8, process 800 may include applying, via the robotic arm and the label printer, the label to the object at the application position (block 850). For example, the label application system may apply, via the robotic arm and the label printer, the label to the object at the application position, as described above.

In some implementations, process 800 includes analyzing, using an image processing model, the object to identify a label receiving area on the object that is to receive the label. The label may be applied to the label receiving area based on controlling the robotic arm to move the label printer across the label receiving area. In some implementations, the label receiving area is identified based on a size of the label.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

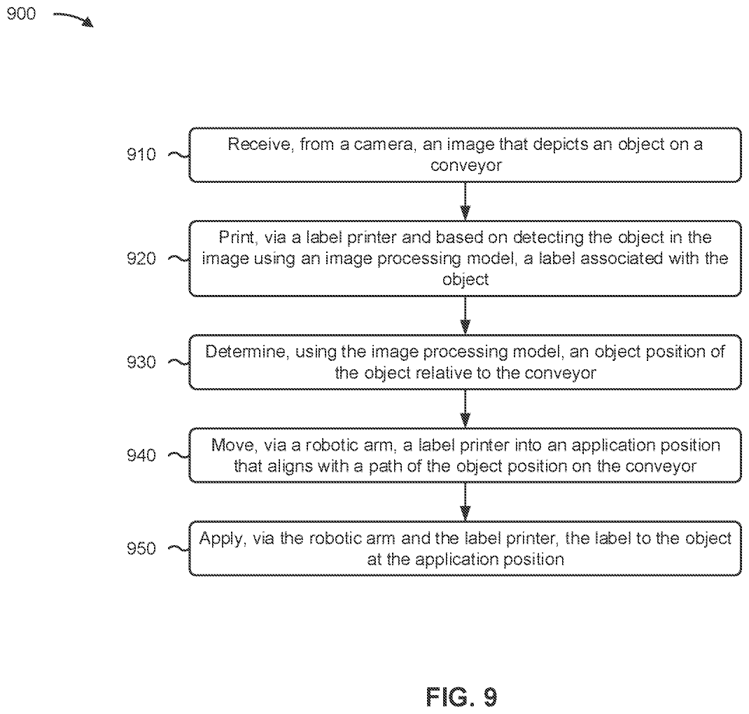

FIG. 9 is a flowchart of an example process 900 associated with a label application system described herein. In some implementations, one or more process blocks of FIG. 9 may be performed by a label application system (e.g., label application system 610 and/or a controller of the label application system). In some implementations, one or more process blocks of FIG. 9 may be performed by another device or a group of devices separate from or including the label application system, such as a label management system (e.g., the label management system 620) and/or an operator station (e.g., the operator station 630). Additionally, or alternatively, one or more process blocks of FIG. 9 may be performed by one or more components of device 700, such as the processor 720, the memory 730, the input component 740, the output component 750, and the communication component 760.

As shown in FIG. 9, process 900 may include receiving, from a camera, an image that depicts an object on a conveyor (block 910). For example, the label application system may receive, from a camera, an image that depicts an object on a conveyor, as described above.

As further shown in FIG. 9, process 900 may include printing, via a label printer and based on detecting the object in the image using an image processing model, a label associated with the object (block 920). For example, the label application system may print, via a label printer and based on detecting the object in the image using an image processing model, a label associated with the object, as described above.

In some implementations, the label application system may process the image to identify an object identifier associated with the object. The label printer may be selected, from a plurality of label printers, based on being associated with the object identifier.

As further shown in FIG. 9, process 900 may include determining, using the image processing model, an object position of the object relative to the conveyor (block 930). For example, the label application system may determine, using the image processing model, an object position of the object relative to the conveyor, as described above.

As further shown in FIG. 9, process 900 may include moving, via a robotic arm, a label printer into an application position that aligns with a path of the object position on the conveyor (block 940). For example, the label application system may move, via a robotic arm, a label printer into an application position that aligns with a path of the object position on the conveyor, as described above.

In some implementations, the robotic arm is attachable to the label printer via a coupler of the robotic arm that couples to an electromechanical coupling of the label printer. The electromechanical coupling may be configured to transfer electrical power from the robotic arm to one or more components of the label printer.

The label application system may cause the robotic arm to remove the label printer from a docking station to the application position. The docking station may be configured to supply power to the label printer prior to the label printer being coupled to the robotic arm.

The label application system may analyze, using the image processing model, the object to identify a label receiving area on the object that is to receive the label, wherein the robotic arm is controlled to apply the label to the label receiving area on the object. In some implementations, the label receiving area is identified based on a size of the label.

As further shown in FIG. 9, process 900 may include applying, via the robotic arm and the label printer, the label to the object at the application position (block 950). For example, the label application system may apply, via the robotic arm and the label printer, the label to the object at the application position, as described above.

Although FIG. 9 shows example blocks of process 900, in some implementations, process 900 may include additional blocks, fewer blocks, different blocks, or differently arranged blocks than those depicted in FIG. 9. Additionally, or alternatively, two or more of the blocks of process 900 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, the term “component” is intended to be broadly construed as hardware, firmware, and/or a combination of hardware and software. As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, or the like) on which machine-readable instructions (e.g., code in the form of, for example, software and/or firmware) can be stored. The instructions may be stored for any suitable duration of time, such as permanently, for an extended period of time (e.g., while a program associated with the instructions is executing), or for a short period of time (e.g., while the instructions are cached, during a buffering process, or the like). Further, as used herein, each of the terms “tangible machine-readable medium,” “non-transitory machine-readable medium” and “machine-readable storage device” is expressly defined to exclude propagating signals. That is, as used in any claim herein, a “tangible machine-readable medium,” a “non-transitory machine-readable medium,” and a “machine-readable storage device,” or the like, should not be interpreted as being implemented as a propagating signal.

As used herein, satisfying a threshold may, depending on the context, refer to a value being greater than the threshold, greater than or equal to the threshold, less than the threshold, less than or equal to the threshold, equal to the threshold, not equal to the threshold, or the like.

It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
detecting, by a device and based on an image, an object on a conveyor;
printing, by the device and via a label printer, a label associated with the object;
determining, by the device, an object position of the object relative to the conveyor;
moving, by the device and via a robotic arm, the label printer into an application position that aligns with a path of the object position on the conveyor; and
applying, by the device and via the robotic arm and the label printer, the label to the object at the application position.

2. The method of claim 1, wherein the label printer is selected, from a plurality of label printers, to apply the label based on a print instruction associated with the object and the label.

3. The method of claim 2, wherein the label is printed to include content that is associated with an object identifier that is indicated on the object.

4. The method of claim 1, wherein the object is detected using an image processing model that is configured to identify the object on the conveyor as depicted in the image.

5. The method of claim 1, further comprising:
analyzing, using an image processing model, the object to identify a label receiving area on the object that is to receive the label,
wherein the label is applied to the label receiving area based on controlling the robotic arm to move the label printer across the label receiving area.

6. The method of claim 5, wherein the label receiving area is identified based on a size of the label.

7. The method of claim 1, wherein the robotic arm is attachable to the label printer via a coupler of the robotic arm and an electromechanical coupling of the label printer.

8. The method of claim 1, wherein moving the label printer into the application position comprises:
causing the robotic arm to remove the label printer from a docking station controlling the robotic arm,
wherein the docking station is configured to supply power to the label printer when the label printer is docked at the docking station, and
wherein the label printer is to receive power from the robotic arm based on being attached to the robotic arm.

9. A device, comprising:
one or more memories; and
one or more processors, coupled to the one or more memories, configured to:
receive, from a camera, an image that depicts an object on a conveyor;
print, via a label printer and based on detecting the object in the image using an image processing model, a label associated with the object;
determine, using the image processing model, an object position of the object relative to the conveyor;
move, via a robotic arm, a label printer into an application position that aligns with a path of the object position on the conveyor; and
apply, via the robotic arm and the label printer, the label to the object at the application position.

10. The device of claim 9, wherein the one or more processors are further configured to:
process the image to identify an object identifier associated with the object,
wherein the label printer is selected, from a plurality of label printers, based on being associated with the object identifier.

11. The device of claim 9, wherein the one or more processors are further configured to:
analyze, using the image processing model, the object to identify a label receiving area on the object that is to receive the label,
wherein the robotic arm is controlled to apply the label to the label receiving area on the object.

12. The device of claim 11, wherein the label receiving area is identified based on a size of the label.

13. The device of claim 9, wherein the robotic arm is attachable to the label printer via a coupler of the robotic arm that couples to an electromechanical coupling of the label printer,
wherein the electromechanical coupling is configured to transfer electrical power from the robotic arm to one or more components of the label printer.

14. The device of claim 9, wherein the one or more processors, to cause the robotic arm to move the label printer into the application position, are configured to:
cause the robotic arm to remove the label printer from a docking station to the application position,
wherein the docking station is configured to supply power to the label printer prior to the label printer being coupled to the robotic arm.

15. A system, comprising:
a label printer;
a camera;
a robotic arm; and
a controller configured to:
receive, from a camera, an image that depicts an object on a conveyor;
print, via a label printer and based on detecting the object in the image using an image processing model, a label associated with the object;
determine, using the image processing model, an object position of the object relative to the conveyor;
move, via a robotic arm, a label printer into an application position that aligns with a path of the object position on the conveyor; and
apply, via the robotic arm and the label printer, the label to the object at the application position.

16. The system of claim 15, wherein the controller is further configured to:
identify, using the image processing model, an object identifier depicted in the image,
wherein the label printer is selected based on being associated with the object identifier.

17. The system of claim 15, wherein the controller is further configured to:
analyze, using the image processing model, the object to identify a label receiving area on the object that is to receive the label,
wherein the robotic arm is controlled to apply the label to the label receiving area on the object.

18. The system of claim 17, wherein the label receiving area is identified based on a size of the label.

19. The system of claim 15, wherein the robotic arm is attachable to the label printer via a coupler of the robotic arm that couples to an electromechanical coupling of the label printer,
wherein the electromechanical coupling is configured to transfer electrical power from the robotic arm to one or more components of the label printer.

20. The system of claim 15, wherein the controller, to move the label printer into the application position, is configured to:
cause the robotic arm to remove the label printer from a docking station to the application position,
wherein the docking station is configured to supply power to the label printer prior to the label printer being coupled to the robotic arm.
